(19) United States
(12) Patent Application Publication
(10) Pub. No.: US 2005/0144511 A1
(43) Pub. Date: Jun. 30, 2005

(54) Disk array system with fail-over and load-balance functions

(76) Inventor: Yung-Chao Chih, Taoyuan County (TW)

Correspondence Address: Chih, Yung-Chao, 7F., No.213 Civic Boulevard Sec.4, Taipei, 105, TW

(21) Appl. No.: 10/959,540

(22) Filed: Oct. 7, 2004

(30) Foreign Application Priority Data
Dec. 25, 2003 (TW) 92136887

(51) Int. Cl. G06F 12/16

(52) U.S. Cl. 714/5; 711/114

(57) ABSTRACT

A disk array system with fail-over and load-balance functions for storing data from a host includes a microprocessor; software providing fail-over and load-balance functions for controlling and handling operation of the host; a plurality of first buses for transmitting data output from the microprocessor, and having a plurality of first channels connected thereto; at least one controller connected to the first buses; a memory connected to the controller and having functions of storing instructions from the microprocessor and data buffering; a plurality of second buses connected to the controller and having a plurality of second channels connected thereto; and a plurality of hard disks connected to a plurality of third channels.

### FIELD OF THE INVENTION

The present invention relates to a disk array system, and more particularly to a disk array system with fail-over and load-balance functions.

### BACKGROUND OF THE INVENTION

The current computer systems demand a large quantity of storing devices to store a huge amount of data. A common solution to the demand developed by computer manufacturers is a disk array system named Redundant Array of Inexpensive Disks (RAID) that combines a computer host with a controller for controlling a plurality of disks. A complete data storing system must have the functions of periodical backup of data, detecting failed disks, detecting failed controller, and balancing data loads. The above-mentioned functions could be realized through cooperation of a computer host with a host-bus adapter (HBA) and connection of a controller to a plurality of operating disks.

For example, U.S. Pat. No. 6,578,158 entitled “Method and apparatus for providing a raid controller having transparent failover and failback” discloses the use of two hubs with a computer host having a host-bus adapter to connect to two similar controllers that have data transmission and fail-over ports providing data-transmission and fail-over functions, respectively, for controlling a plurality of disks. Data in the host pass the two hubs and are sent via the data transmission ports of the controllers to the disks for storage. Similarly, data stored in the disks could be transmitted via the same paths to the host for running. The controllers and the disks have respective unique identifiers and logic unit numbers for communicating with the computer host. The controllers communicate with one another via a plurality of channels between them. These channels may be, for example, a small computer system interface. The controllers continuously communicate with one another using “ping” instruction to verify whether the controllers operate normally. In a general state, data in the computer host are transmitted via a primary controller to the disks for storage, and data stored in the disks could be sent back via the primary controller to the host for processing. When one of the controllers communicates with the other one using the ping instruction and does not receive a responding message, the controller in normal operation would determine that the other controller is in a failed condition and use the fail-over port thereof to receive and record the unique identifier and logic unit number of the failed controller, so as to transfer via the fail-over port of the normal controller the data that is originally to be transmitted via the data transmission port of the failed controller, and thereby enables the disk array system to maintain a normal operation thereof.

An advantage of U.S. Pat. No. 6,578,158 is the controllers provide data transmission and fail-over functions, and it is not necessary for an operating system of the computer host to handle disk errors or failed controllers. However, the method and apparatus disclosed in U.S. Pat. No. 6,578,158 is very expensive and not affordable by general consumers because it requires high cost for hubs and needs high-performance controllers to configure the whole disk array system. It is therefore tried by the inventor to develop a disk array system that is economical and practical for use, and can therefore effectively solve the above-mentioned problem.

### SUMMARY OF THE INVENTION

A primary object of the present invention is to provide a disk array system that includes specific software installed on a computer host to provide fail-over and load-balance functions, so that it is possible to utilize a high-performance microprocessor in a computer host to perform the fail-over and load-balance functions of the disk array system without using a controller to achieve the same functions at high operating cost.

Another object of the present invention is to provide a controller adapted to transmit data to different hard disks.

A further object of the present invention is to provide a memory having the functions of storing instructions and data buffering.

A still further object of the present invention is to provide a serial ATA (SATA) bus adapted to transmit data from a computer host to hard disks for storage, or transmit data stored in hard disks back to the computer host for processing.

To achieve the above and other objects, the disk array system of the present invention stores data from the host in a fault-tolerant processing manner, and includes a microprocessor; software providing fail-over and load-balance functions for controlling and handling operation of the host; a plurality of first buses connected to the microprocessor, and having a plurality of first channels connected thereto; at least one controller connected to the first buses; a memory connected to the controller and having functions of storing instructions and data buffering; a plurality of second buses connected to the controller and having a plurality of second channels connected thereto; and a plurality of hard disks connected to a plurality of third channels each.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing a hardware configuration of the disk array system of the present invention;

FIG. 2 is a flowchart showing steps included in the operation of the disk array system of the present invention;

FIG. 3 is a schematic view showing a first example of operation of the disk array system of the present invention;

FIG. 4 is a schematic view showing a second example of operation of the disk array system of the present invention;

FIG. 5 is a schematic view showing a third example of operation of the disk array system of the present invention; and

FIG. 6 is a schematic view showing a fourth example of operation of the disk array system of the present invention.

### DETAILED DESCRIPTION OF THE PREFERRED EMBODIMENTS

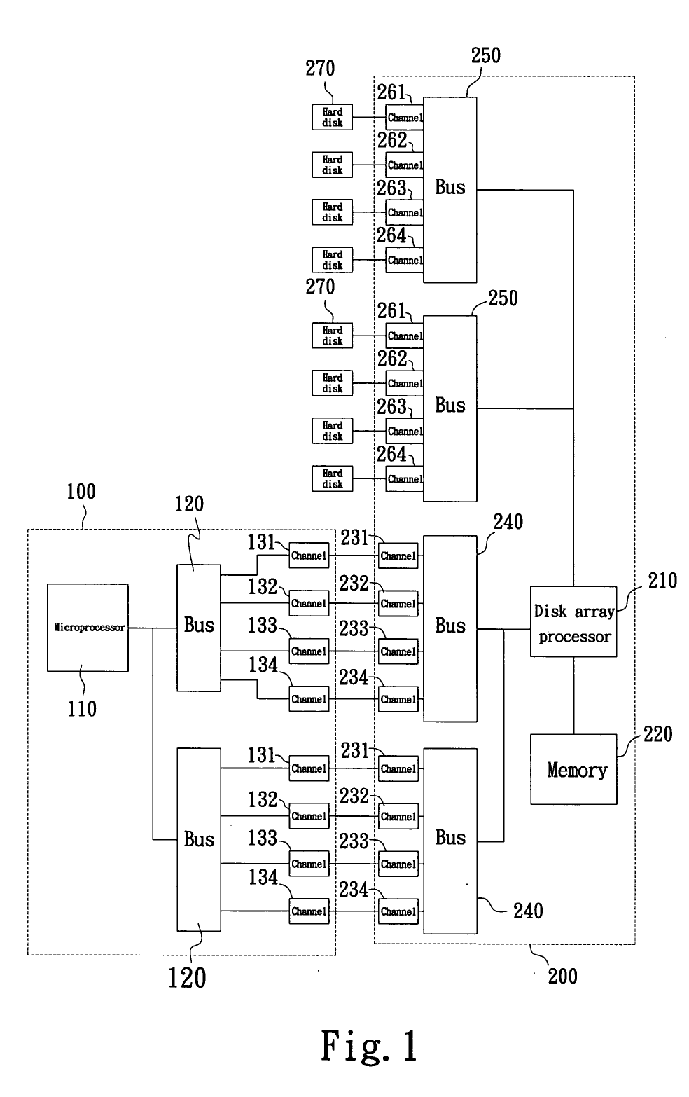

Please refer to FIG. 1 that is a schematic view showing a hardware configuration of a disk array system with fail-over and load-balance functions according to the present invention. As shown, the disk array system includes a host 100, a controller 200, and a plurality of hard disks 270.

The host 100 has a microprocessor 110, on which specific software (not shown) is installed to provide fail-over and load-balance functions, and a plurality of first buses 120 connected to a plurality of first channels 131, 132, 133, 134 each, so that data in the host 100 is transferred by the microprocessor 110 via the first buses 120 and the first channels 131, 132, 133, 134 to the controller 200.

The controller 200 includes a disk array processor 210, a memory 220 having functions of storing fail-over and load-balance instructions and data buffering to restore data transferred thereto, a plurality of second buses 240 connected to a plurality of second channels 231, 232, 233, 234 each for transferring data from the first channels 131, 132, 133, 134 to the disk array processor 210 via the second buses 240, a plurality of third buses 250 connected to a plurality of third channels 261, 262, 263, 264 each for transferring data from the memory 220 via the third buses 250 to the hard disks 270 for storage. Data stored in the hard disks 270 could be transferred back to the microprocessor 110 of the host 100 via the same paths when the same instructions are given.

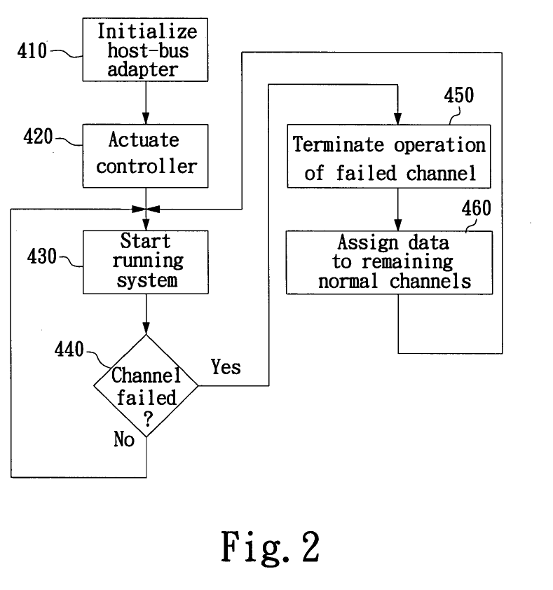

Please refer to FIG. 2 that is a flowchart showing steps included in the operation of the disk array system of the present invention shown in FIG. 1. First, the microprocessor 110 of the host 100 runs the specific software to initialize a host-bus adapter (Step 410) and then actuates the controller 200 (Step 420). Then, the system starts running to perform data transmission between the host 100 and the hard disks 270 (Step 430). More specifically, when the microprocessor 110 or the disk array processor 210 receives a load-balance instruction from the specific software, data to be transferred is divided into several parts, which are then separately assigned to the first or the second channels 131-134 or 231-234 to transfer to the first or the second buses 120 or 240, respectively, before transferred to the hard disks 270 or the microprocessor 110 of the host 100. During the data transmission, the first channels 131-134 of the first buses 120, which and all other second buses are serial ATA (SATA) buses, on the host 100 are automatically continuously detected for normal operation thereof (Step 440). In the event any one or more of the first channels 131-134 are detected as failed, the microprocessor 110 of the host 100 immediately gives a fail-over instruction via the specific software to terminate the operation of the failed first channels (Step 450). Thereafter, the microprocessor 110 of the host 100 would give a load-balance instruction for the data that are originally to be sent via the failed first channels to be transferred via other normal first channels (Step 460).

In a disk array system according to a preferred embodiment of the present invention, data could be transferred by the microprocessor 110 from the host 100 via the controller 200 to the hard disks 270 for storage. The disk array system of the present invention is characterized in the specific software that has the functions of terminating failed channels and balancing load on remaining normal channels to ensure safe transmission of data.

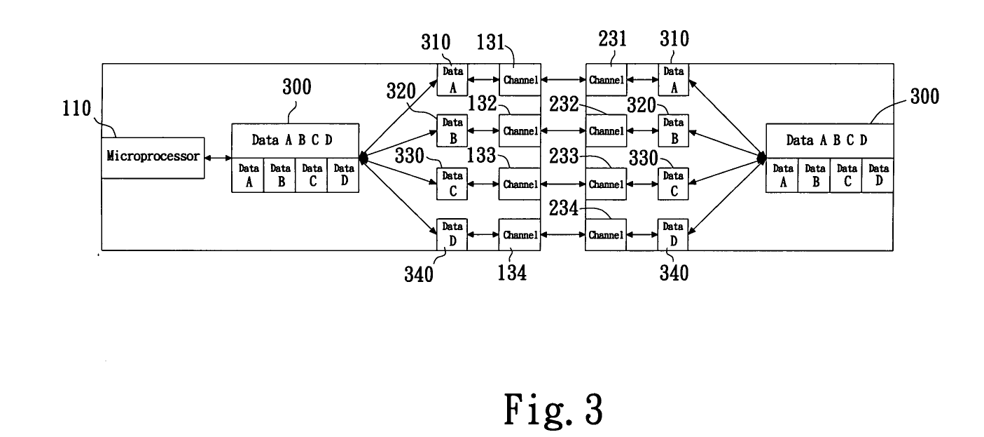

Please refer to FIG. 1 along with FIG. 3 that shows a first example of operation of the present invention. When the disk array system of the present invention operates normally, the microprocessor 110 of the host 100 or the disk array processor 210 of the controller 200 divides data ABCD 300 into, for example, four parts, namely, data A 310, data B 320, data C 330, and data D 340, which are separately sent from the host 100 to the first channels 131-134 via the first buses 120, and then transferred to the second channels 231-234, respectively. Data A 310, data B 320, data C 330, and data D 340 transferred to the second channels 231-234 are then sent via the second buses 240 to the disk array processor 210 of the controller 200 and restored to data ABCD 300, which is transferred to the hard disks 270 for storage via the third buses 250 and the third channels 261-264.

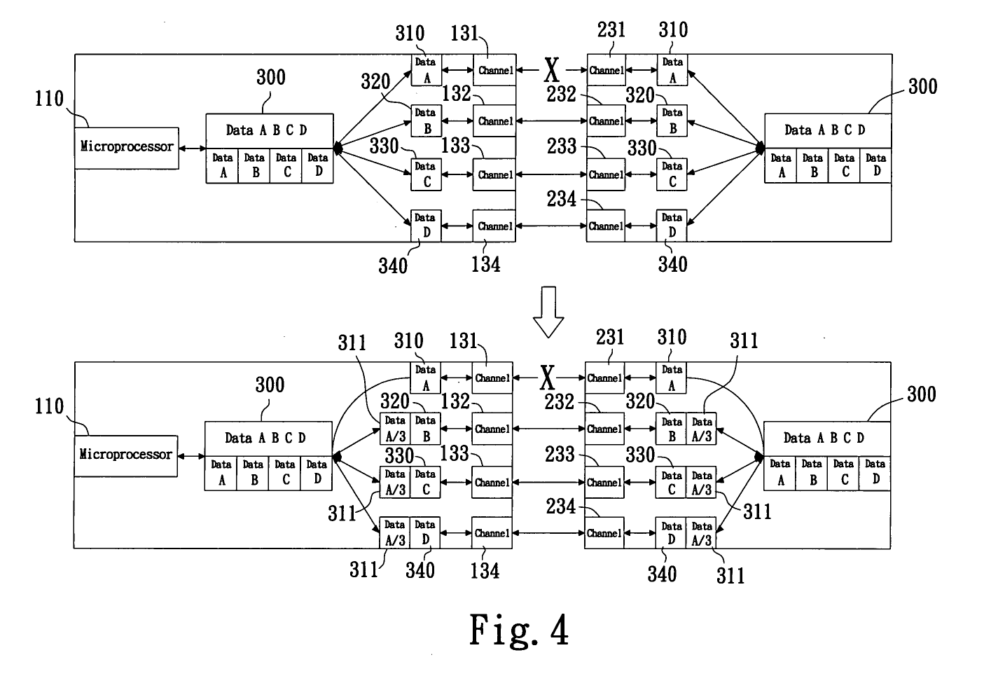

Please refer to FIG. 1 along with FIG. 4 that shows a second example of operation of the disk array system of the present invention. When the microprocessor 110 detects a failure in communication between, for example, the first channel 131 and the second channel 231, the microprocessor 110 would first terminate the operation between these two channels 131 and 231, and then divides data A 310, which is originally to be transmitted via the first channel 131 and the second channel 231, into three equal parts, namely, data A/3 311, so that the three equal parts of data A 310, that is, data A/3 311, are sent out of the host 100 along with data B 320, data C 330, and data D 340 via the first channels 132-134, respectively, before transferred via the second channels 232-234 and the second buses 240 to the disk array processor 210 of the controller 200, at where the three divided parts of data A 310, that is, data A/3 311, along with data B 320, data C 330, and data D 340 are restored to data ABCD 300, which is transferred via the third buses 250 and the third channels 261-264 to the hard disks 270 for storage.

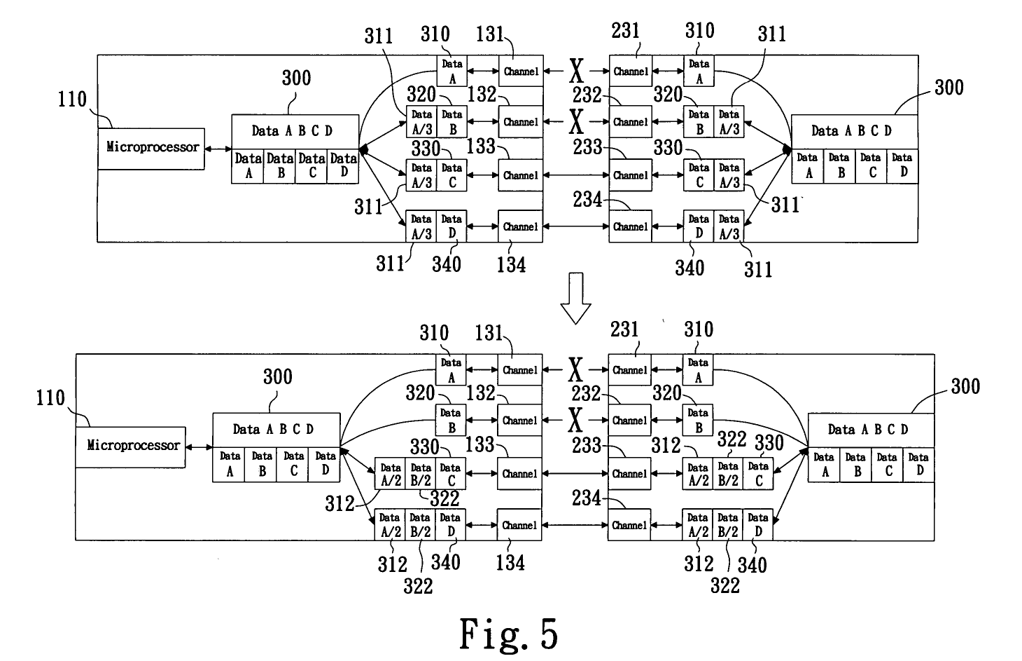

Please refer to FIG. 1 along with FIG. 5 that shows a second example of operation of the disk array system of the present invention. When the microprocessor 110 detects failures in communication between, for example, the first channel 131 and the second channel 231, as well as the first channel 132 and the second channel 232, the microprocessor 110 would first terminate the operation between the channels 131 and 231, as well as the channels 132 and 232, and then divides data A 310, which is originally to be transmitted via the first channel 131 and the second channel 231, into two equal parts, namely, data A/2 312, and data B 320, which is originally to be transmitted via the first channel 132 and the second channel 232, into two equal parts, namely, data B/2 322, so that the two equal parts of data A 310, that is, data A/2 312, and the two equal parts of data B 320, that is, data B/2 322, are sent out of the host 100 along with data C 330 and data D 340 via the remaining first channels 133-134, respectively, before transferred via the second channels 233-234 and the second buses 240 to the disk array processor 210 of the controller 200, at where the two divided parts of data A 310, that is, data A/2 312, and the two divided parts of data B 320, that is, data B/2 322, along with data C 330 and data D 340 are restored to data ABCD 300, which is transferred via the third buses 250 and the third channels 261-264 to the hard disks 270 for storage.

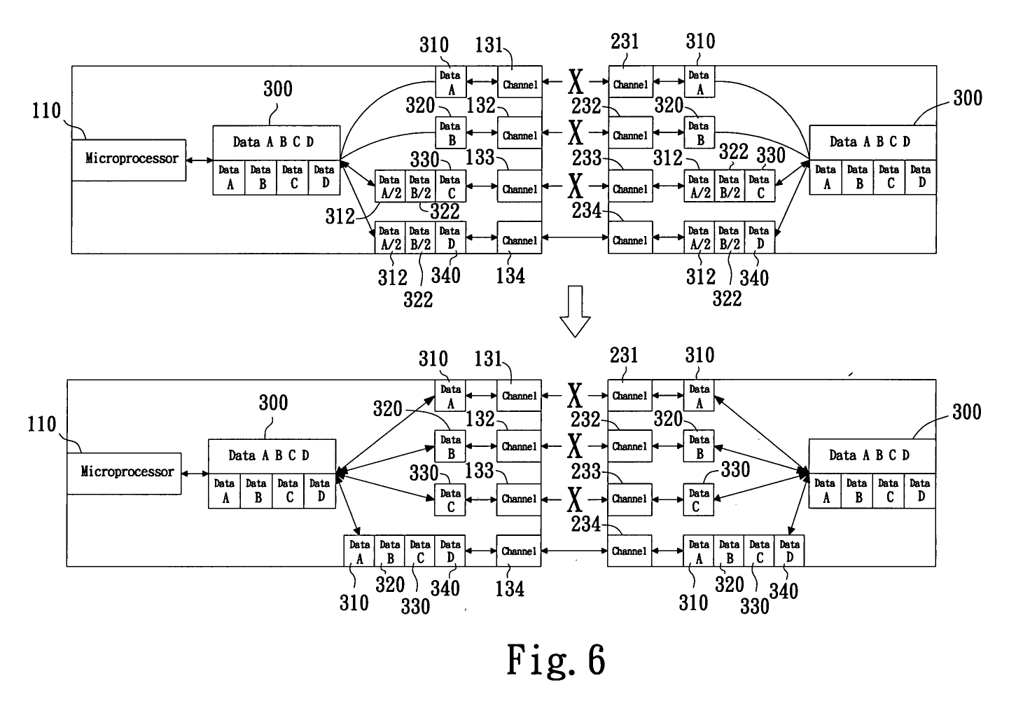

Please refer to FIG. 1 along with FIG. 6 that shows a third example of operation of the disk array system of the present invention. When the microprocessor 110 detects failures in communication between, for example, the first channel 131 and the second channel 231, the first channel 132 and the second channel 232, as well as the first channel 133 and the second channel 233, the microprocessor 110 would first terminate the operation between the channels 131 and 231, the channels 132 and 232, as well as the channels 133 and 233, and then send data A 310, which is originally to be transmitted via the first channel 131 and the second channel 231, data B 320, which is originally to be transmitted via the first channel 132 and the second channel 232, and data C 330, which is originally to be transmitted via the first channel 133 and the second channel 233, out of the host 100 along with data D 340 via the remaining first channels 134 before transferred via the second channels 234 and the second buses 240 to the disk array processor 210 of the controller 200, at where data A 310, data B 320, data C 330, and data D 340 are restored to data ABCD 300, which is then transferred via the third buses 250 and the third channels 261-264 to the hard disks 270 for storage.

The present invention utilizes the operating ability of the high performance microprocessor of existing computer host, specifically designed software, and a functionally simplified controller to configure a disk array system that has high transmission capability and reduced cost, and ensures integrity of data transferred via the system, and thereby eliminates the shortcomings in the conventional disk array system of requiring expensive hubs and controllers to handle fail-over and load-balance of channels.

1. A disk array system with fail-over and load-balance functions for storing data from a host, comprising:
a microprocessor;
software providing fail-over and load-balance functions for controlling and handling operation of said host;
a plurality of first buses for transmitting data output from said microprocessor, and having a plurality of first channels connected thereto;
at least one controller connected to said first buses;
a memory connected to said at least one controller and having functions of storing instructions and data buffering;
a plurality of second buses connected to said at least one controller and having a plurality of second channels connected thereto; and
a plurality of hard disks connected to a plurality of third channels.

2. The disk array system with fail-over and load-balance functions as claimed in claim 1, wherein said first buses are driven by said microprocessor to perform transmission of data from said host.

3. The disk array system with fail-over and load-balance functions as claimed in claim 2, wherein said at least one controller is driven by said microprocessor after said first buses have been driven.

4. The disk array system with fail-over and load-balance functions as claimed in claim 3, wherein said microprocessor is adapted to detect for any failure in any one of said a plurality of first channels and terminate operation of said failed first channel when such a failure is detected, and divide said data that is originally to be sent via said failed first channel into several equal parts for transmitting via remaining ones of said first channels that operate normally.

5. The disk array system with fail-over and load-balance functions as claimed in claim 4, wherein each of said remaining normal ones of said first channels transmits not only one of said equally divided parts of said data originally to be sent via said failed first channel, but also data originally assigned thereto for transmission.

6. The disk array system with fail-over and load-balance functions as claimed in claim 1, wherein said first and said second buses are serial ATA buses.
